(19) United States
(12) Patent Application Publication
(10) Pub. No.: US 2025/0232746 A1
(43) Pub. Date: Jul. 17, 2025

(54) APPLICATION PROCESSOR, ELECTRONIC DEVICE INCLUDING THE SAME, AND OPERATING METHOD THEREOF

(71) Applicant: SAMSUNG ELECTRONICS CO., LTD., Suwon-si (KR)

(72) Inventors: Junghak Lee, Suwon-si (KR); Jiyu Park, Suwon-si (KR); Yon Jun Shin, Suwon-si (KR); Hoonmo Yang, Suwon-si (KR)

(73) Assignee: SAMSUNG ELECTRONICS CO., LTD., Suwon-si (KR)

(21) Appl. No.: 18/763,541

(22) Filed: Jul. 3, 2024

(30) Foreign Application Priority Data
Jan. 15, 2024 (KR) 10-2024-0005880

(51) Int. Cl. G09G 5/18

(52) U.S. Cl. CPC G09G 5/18; G09G 2330/021; G09G 2340/0435; G09G 2354/00

(57) ABSTRACT

A method of operating an application processor includes determining whether to update configuration information according to an application, issuing a synchronous command when the configuration information is to be updated; transmitting the synchronous command to a display driver integrated circuit, and transmitting frame data according to a frame rate corresponding to the synchronous command to the display driver integrated circuit after a transmission acknowledgment of the synchronous command is received from the display driver integrated circuit.

### CROSS-REFERENCE TO RELATED APPLICATION

This application claims priority to Korean Patent Application No. 10-2024-0005880 filed on Jan. 15, 2024 in the Korean Intellectual Property Office, the disclosure of which being incorporated by reference herein in its entirety.

### BACKGROUND

Example embodiments relate to an application processor, an electronic device including the same, and a method of operating the same.

Generally, a display serial interface (DSI) may be an interface for communication between a display device and a host controller used in a mobile device and an embedded system. The DSI interface may be mainly used to transmit display data from a device such as a smartphone, a tablet, and a portable display device. The DSI interface may operate in command mode and video mode.

### SUMMARY

It is an aspect to provide an application processor which may transmit a synchronous command at a time of a specific image transmission, an electronic device including the same, and a method of operating the same.

According to an aspect of one or more example embodiments, a method of operating an application processor may include determining whether to update configuration information according to an application; issuing a synchronous command when the configuration information is to be updated; transmitting the synchronous command to a display driver integrated circuit; and after receiving a transmission acknowledgment of the synchronous command from the display driver integrated circuit, transmitting frame data according to a frame rate corresponding to the synchronous command to the display driver integrated circuit.

According to another aspect of one or more example embodiments, an application processor may include a synchronous command storage configured to store a synchronous command; a general command storage configured to store a general command; a display control logic configured to determine whether configuration information is to be changed according to an application and to generate the synchronous command when the configuration information is to be changed; an arbitration logic configured to arbitrate transmission of the synchronous command, the general command, and frame data; a frame section setter configured to set frame sections for each of a video mode and a command mode; a packaging logic configured to convert data output by the arbitration logic into a packet; and a physical layer circuit configured to transmit the packet to a display driver integrated circuit.

According to yet another aspect of one or more example embodiments, a method of operating an application processor includes transmitting a synchronous command to a display driver integrated circuit in a command transmission allowable section in video mode; and transmitting a general command to the display driver integrated circuit after a transmission acknowledgment of the synchronous command is received.

According to yet another aspect of one or more example embodiments, an electronic device may include a panel; a display driver integrated circuit configured to control the panel and to determine whether update conditions of the panel are satisfied in a low-frequency driving mode; an application processor configured to transmit a frame to the display driver integrated circuit by a first interface method and to receive a new frame request and timing information from the display driver integrated circuit by a second interface method during the low-frequency driving mode; and a power management chip configured to output driving voltages for driving the panel, the display driver integrated circuit, and the application processor, wherein the application processor issues a synchronous command to change a frame rate or a resolution by frame interval according to an application in video mode, and synchronizes the display driver integrated circuit with setting information using the synchronous command.

### BRIEF DESCRIPTION OF DRAWINGS

The above and other aspects will be more clearly understood from the following detailed description, taken in combination with the accompanying drawings, in which:

FIG. 1 is a diagram illustrating a display system according to an example embodiment;

FIG. 2 is a diagram illustrating a configuration storage according to an example embodiment;

FIG. 3 is a diagram illustrating an example of image missing without a synchronous command;

FIG. 4 is a diagram illustrating an example of image collision without a synchronous command;

FIG. 5 is a timing diagram illustrating an operation of an application processor (AP) using a synchronous command according to an example embodiment;

FIG. 6 is a flowchart illustrating an operation in which an AP and a Display Driver Integrated Circuit (DDI) update configurations thereof in a same frame according to an example embodiment;

FIG. 7 is a diagram illustrating a related art AP data arbitration operation;

FIG. 8 is a diagram illustrating a data arbitration operation according to an example embodiment;

FIG. 9 is a diagram illustrating a timing of a protocol of a synchronous command transmission interface in an AP according to an example embodiment;

FIG. 10 is a timing diagram illustrating an example of when emission synchronization is used in an AP according to an example embodiment;

FIG. 11 is a diagram illustrating timing when an AP does not use a light emission synchronization signal when transmitting a synchronous command according to an example embodiment;

FIG. 12 is a ladder diagram illustrating an operation of a display system according to an example embodiment;

FIG. 13 is a diagram illustrating a mobile device according to an example embodiment; and

FIG. 14 is a diagram illustrating an electronic device according to an example embodiment.

### DETAILED DESCRIPTION

Hereinafter, various embodiments will be described as below with reference to the accompanying drawings.

A related art application processor arbitrates between image data and command data to determine which of the image data and the command data to transmit and sends packets by packaging the corresponding image data and command data into packet form. An application processor according to various embodiments and a method of operation thereof may perform arbitration, the arbitration including special command (e.g., synchronization commands) data to be transmitted in synchronization with the transmission timing of image data. In an embodiment, the application processor according to embodiments may include separate storage and interfaces for storing synchronization command data to be synchronized with image data at the transmission timing. In an embodiment, the application processor may include signals to request the transmission of synchronization command data from display control logic and signals to acknowledge transmission completion. In an embodiment, the application processor may include frame partition control logic and arbitration logic, where the arbitration logic may include logic to distinguish/mediate between general command data and synchronization command data.

An application processor according to various embodiments and an operating method thereof may control the priority of transmission by storing synchronization commands in a separate storage, thereby preventing the synchronization commands from mixing with general commands. In an example embodiment, the application processor and the operating method thereof may determine the timing of transmission only when receiving transmission request signals. The application processor and the operating method may ensure that synchronization commands have been transmitted to the Display Driver Integrated Circuit (DDI) before specific image data transmissions by confirming the special command transmissions through completion signals of the special command transmissions. The application processor and the operating method may enable the alteration of frame rates starting from specific frame image data during operation by transmitting information to the DDI via synchronization commands, thus allowing changes at desired points. The application processor and the operating method may change the frame rates of both DDI and AP simultaneously, which is effective when utilizing Variable Refresh Rate (VRR).

By adding a dedicated storage for synchronization commands and by confirming the timing of synchronization command transmissions and completion, data flow control may be facilitated. The application processor and the operating method may mediate between three types of data: image data, general command data, and special commands (e.g., synchronization commands). Synchronization commands, which allow for the determination of a transmission timing tailored to specific image data, are suitable for transmitting image metadata. Video timing may include horizontal/vertical video timings. The horizontal video timing may correspond to a scan line, and the horizontal video timing may correspond to a frame. In the mobile industry processor interface (MIPI) display serial interface (DSI) standard, the operation mode may be defined as command mode and video mode, respectively, according to whether the video timing is managed by a peripheral link controller or a host processor.

When operating in command mode, the AP may transmit image data in a burst, and the DDI may store the image data in the frame buffer and may configure the video timing according to a panel situation. When operating in video mode, the DSI host link controller of the AP may count each video timing, may transmit a horizontal/vertical synchronization packet, and a DSI peripheral link controller of the DDI may manage timing based on the received synchronization packet. The period from when the horizontal synchronization packet is transmitted until the vertical synchronization packet of the subsequent frame is transmitted may include vertical activation/porch sections.

In the DSI standard, when the DSI operates in video mode, various operations such as maintaining a low power state in a porch section in which the transmit synchronization packet and the image packet are not transmitted within a frame, and transmitting the command packet may be performed. When operating in command mode, transmitting image data in a burst within a frame and maintaining a low-power state or transmitting command data in the remaining section may be performed.

Variable refresh rates (VRR) provide a function of changing a configuration such as a frame rate and/or resolution according to an application. As the demand for dynamic variable refresh rates (VRR) has increased, it may be advantageous to change properties of an image transmitted during a display operation to a frame unit. In this case, it may be advantageous to change configurations of the AP and the DDI in the same frame. To this end, it may be advantageous to synchronize the time point at which the AP transmits configuration information to the DDI as a command, with the time point at which the AP updates the frame configuration. In other words, it may be advantageous to control the time point at which the AP transmits a command to the DDI. The application processor and the method of operating the same according to an example embodiment may transmit data for which it may be advantageous to guarantee transmission at a specific time point.

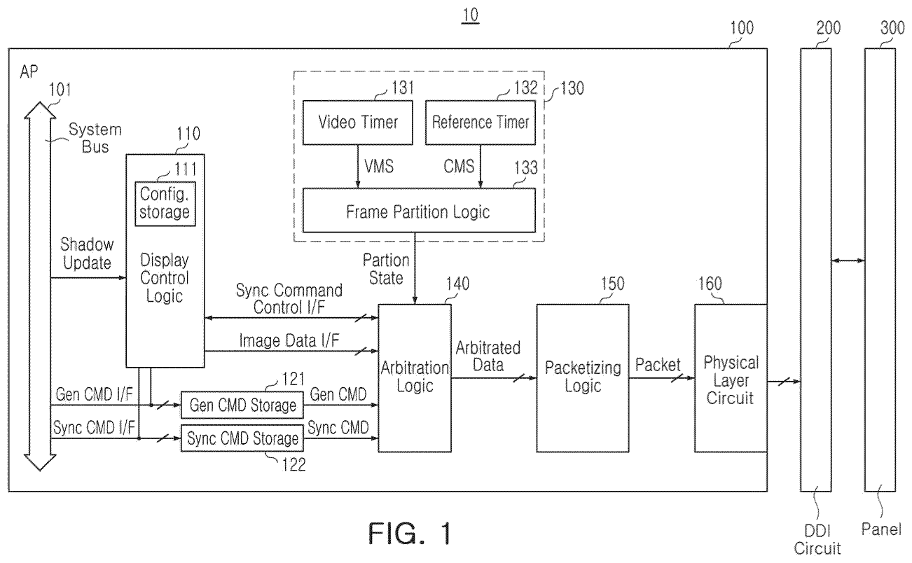

FIG. 1 is a diagram illustrating a display system 10 according to an example embodiment. Referring to FIG. 1, the display system 10 may include an application processor (AP) 100, a Display Driver Integrated Circuit (DDI) 200 and a panel 300.

The display system 10 may be implemented as a smartphone, tablet personal computer (PC), mobile phone, video phone, e-book reader, desktop PC, laptop PC, netbook computer, workstation, server, mobile medical device, camera, wearable device (e.g., smart Glasses, head mounted device (HMD), electronic clothing, electronic bracelet, electronic necklace, electronic accessory, smart mirror, or smart watch), an Internet of Things (IoT) device, etc.

The application processor (AP) 100 may be implemented to control overall operation of the display system 10. The AP 100 may output frame data to the DDI 200 through a channel in a first interface method. Here, the first interface method may be one of mobile industry processor interface (MIPI), high definition multimedia interface (HDMI), display port (DP), low power display port (LPDP) or advanced low power display port (ALPDP). However, the interface method in the example embodiment is not limited thereto.

In low-frequency operation mode, the AP 100 may receive state information of the DDI 200 through a tearing effect (TE) pin and may generate a synchronous signal corresponding to display-related timing information through an error detection flag pin. In an example embodiment, the timing information may include a horizontal synchronous signal of the DDI 200, an active frame synchronized with a signal, or a 1/k (where k is a natural number of 2 or more) active frame synchronized with a signal. In some example embodiments, the timing information may be generated using a driving frequency of the DDI 200. The AP 100 may receive the timing information according to a second interface method. Here, the second interface method may be inter-integrated circuit I2C or S-Wire (Single-wire Universal Asynchronous Receiver-Transmitter UART) communication interface. However, the communication interface is not limited thereto. The AP 100 may receive state information from the DDI 200 through the tearing effect (TE) pin during low-frequency operation mode. The state information may include a frame request. The AP 100 may transmit the timing information to the DDI 200 through an error detection flag pin. The AP 100 may be synchronized with the timing of DDI 200 using the timing information.

The AP 100 may include a display control logic 110, a general command (gen CMD) storage 121, a synchronous command (Sync CMD) storage 122, a frame section setter circuit 130, an arbitration logic 140, a packaging logic 150, and a physical layer circuit 160, connected to a system bus 101.

The display control logic 110 may perform a synchronous command control interface operation or a shadow update operation.

The synchronous command control interface operation may include an operation of recognizing which image a synchronous command is to be synchronized with and transmitted, and an operation of identifying a transmission acknowledgment. The synchronous command control interface operation may be performed by a synchronous command transmission request signal and a synchronous command transmission acknowledgment signal. The synchronous command transmission request signal may be configured to trigger transmission of a synchronous command.

By transmitting a synchronous command transmission request signal to the arbitration logic 140, the display control logic 110 may transmit the synchronous command preferentially to the general command in a section in which the synchronous command may be transmitted. The synchronous command transmission acknowledgment signal may be configured as an acknowledgment signal indicating that transmission of a synchronous command has been completed. In an example embodiment, the acknowledgment signal may be maintained at a high level while transmitting a synchronous command. When it is determined that synchronous command transmission is not able to be completed from the time point when the synchronous command request was received to the command transmission allowable section, the request may be held until the subsequent command transmission allowable section. The synchronous command transmission acknowledgment signal may be de-asserted after the entirety of stored synchronous commands have been transmitted. As described above, the arbitration logic 140 may determine whether a synchronous command is transmitted using the synchronous command transmission request signal and the synchronous command transmission acknowledgment signal. The display control logic 110 may ensure an operation of transmitting image data in a state in which the entirety of synchronous commands have been transmitted by identifying whether synchronous command transmission has been completed.

In the shadow update operation, the configuration may be expected to be changed in frame unit when other configurations change, for example, when gamma look-up table including a frame rate or a resolution change. In this case, a shadow update logic may be used.

The general command (gen CMD) storage 121 may be implemented to store a general command. The synchronous command (Sync CMD) storage 122 may be implemented to store a synchronous command. In an example embodiment, the synchronous command may be a command for which a time of transmission is important and needs to be guaranteed. In an example embodiment, the general command may be a command that is less important that the synchronization command and for which a time of transmission does not need to be guaranteed. The synchronous command may be stored in the synchronous command storage 122 to be distinguished from a general command. The synchronous command storage 122 may be accessed independently from the general command storage 121. In an example embodiment, since the general command storage 121 and the synchronous command storage 122 are separated, the method of writing commands may include separately allocating a bus address for a synchronous command or adding a separate direct memory access (DMA) for the synchronous command, thereby preventing mixing of general and synchronous command inputs.

The frame section setter circuit 130 may include a video mode timer 131, a command mode timer 132, and a frame partition logic 133. The video mode timer 131 may be activated in video mode. The command mode timer 132 may be activated in command mode. The frame partition logic 133 may be implemented to distinguish sections within a frame. For example, the frame partition logic 133 may distinguish among a section in which image data is transmitted, a section in which command data is transmitted, and a section in which the entirety of data is not transmitted. In an example embodiment, the frame partition logic 133 may distinguish sections within the frame using the video timer 131 in video mode and the refresh timer 132 in command mode. In an example embodiment, a section in which command data may be transmitted may be divided into a section in which a synchronous command/general command may be transmitted and a section in which only a general command may be transmitted. In sections in which the synchronous command may be transmitted, priorities may be set to synchronous commands by the arbitration logic 140 and the synchronous commands may be transmitted. Thereafter, the general command may be transmitted.

The arbitration logic 140 may select which data to transmit according to the sections distinguished by the frame partition logic 133, may read from storage, and may instruct packaging. For example, the arbitration logic 140 may arbitrate image data, general command data, and synchronous command data. When receiving information indicating a section in which a synchronous command may be transmitted from the frame partition logic 133, the arbitration logic 140 may read the stored synchronous command data from the synchronous command (Sync CMD) storage 122 and may transmit the synchronous command data to the packaging logic 150. The synchronous command implemented in packet form in the packaging logic 150 may be transmitted to the DDI 200 through the physical layer circuit 160.

The packaging logic 150 may implement data in packet form. For example, in an example embodiment, the packaging logic 150 may packetize the data. The physical layer circuit 160 may be implemented to output packet data to the DDI 200.

The DDI 200 may be implemented to control operation of the panel 300. For example, the DDI 200 may change the data transmitted from the AP 100 to the panel 300 and may transmit the changed data to the panel 100. In an example embodiment, the DDI 200 may control a state (a sleep state, a display-on state, a display-off state, or the like) of the panel 300. The DDI 200 may be implemented to not include a frame buffer (e.g., a graphic random access memory (GRAM)) configured to store frame data received from the AP 100. The DDI 200 may be implemented to display frame data on the panel 300 in response to timing information in low-frequency operation mode (e.g., 1 Hz or 10 Hz operation mode). Here, the timing information may be received from the AP 100 in low-frequency operation mode.

The panel 300 may be implemented to display image data. In an example embodiment, the panel 300 may be implemented as a thin film transistor liquid crystal display (TFTLCD) panel, a light emitting diode (LED) display panel, an organic LED (OLED) display panel, an active matrix OLED (AMOLED) display panel, or a flexible display panel. In an example embodiment, the panel 300 may be implemented as a low temperature poly crystalline oxide (LTPO) panel. The LTPO panel is described in greater detail in U.S. Patent Application Publication No. 2022-0114957, which is incorporated by reference herein in its entirety. The panel 300 may include a plurality of pixels arranged in a matrix form having a plurality of rows and a plurality of columns. Each of the plurality of pixels may be connected to the plurality of data lines and the plurality of source lines. In an example embodiment, the pixel may be a structure in which sub-pixels Red, Green, and Blue are disposed adjacently to each other in relation to the designated color display, and one pixel may include an RGB sub-pixel (a RGB stripe layout structure) or RGGB sub-pixels (a pentile layout structure). In an example embodiment, the arrangement structure of RGGB sub-pixels may be replaced with the RGBG sub-pixel arrangement structure. In some example embodiments, the pixels may be replaced with the RGBW sub-pixel arrangement structure.

A related art application processor may use a method of transmitting data other than images in the form of a command packet suggested by the DSI standard. Since there is no dependency between command data and image data, command data may be transmitted in the order in which the command data is stored in a section within a frame in which the data is able to be transmitted. In this case, data which has not yet been transmitted may be transmitted in a subsequent frame. Accordingly, in the case of information corresponding to metadata of a specific image, when implemented by a related art application processor, the metadata may be transmitted later than the image data or may be transmitted more than one frame earlier. Therefore, there is a disadvantage in that it may be difficult to match metadata and image data in the DDI. Since it is difficult for the related art AP to identify whether transmission of a specific command to DDI has been completed, it may be difficult to synchronize the time points at which the AP and DDI the update the configuration.

The AP 100 in an example embodiment may give priority to command transmission by separating a command (e.g., a synchronous command) for which a time of transmission is important, from an existing general command. For example, the AP 100 may separate the command (e.g., a synchronous command) for which the time of transmission is important from the existing general command by storing the command (e.g., a synchronous command) for which the time of transmission is important separately from the existing general command. The AP 100 in an example embodiment may control the time of transmission of a synchronous command through a request signal and may identify whether transmission is complete using an acknowledgment signal. The AP 100 in an example embodiment may synchronize the time of transmission of image data and command data as described above, such that the AP 100 and the DDI 200 may share image update information in the same frame.

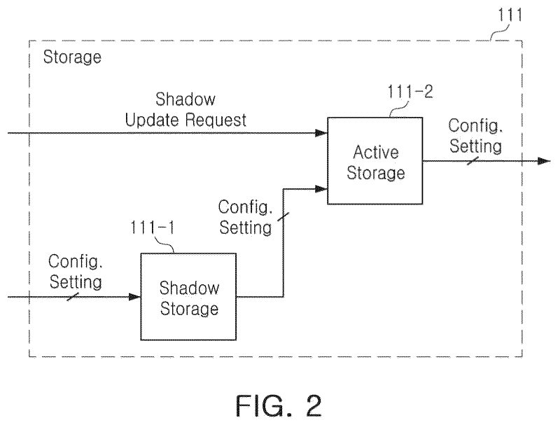

FIG. 2 is a diagram illustrating a configuration storage according to an example embodiment. Referring to FIG. 2, the configuration storage 111 may include a shadow storage 111-1 and an active storage 111-2. The configuration storage 111 may include a shadow update logic. In an example embodiment, the shadow update logic may be implemented as a shadow storage 111-1, an active storage 111-2, and a shadow update request interface.

The shadow storage 111-1 may be implemented in the form of a clone of storages of which a value may need to be changed in frame unit among software accessible storages. When the value of the active storage 111-2 used for ongoing operations, such as frame configuration, is changed in the middle of a frame, the change may immediately affect the frame. Accordingly, values which may need to be changed in the subsequent frame may be input into the shadow storage 111-1. Values stored in the active storage 111-2 may be used in actual operations.

The shadow update request may be to overwrite the active storage 111-2 with a value stored in the shadow storage 111-1. When a configuration setting value to change is input to the shadow storage 111-1, and the software transmits a request signal, and hardware may simultaneously update the values of the shadow storage 111-1 to the active storage 111-2 at the start of the subsequent frame. Thereafter, the shadow update operation may be terminated by transmitting an update acknowledgment signal to the software.

The AP 100 according to an example embodiment may extend a shadow update logic for synchronous command transmission. When changing the configuration of the frame, the display control logic 110 may update the shadow storage 111-1 after transmission of the synchronous command matching the frame is completed, rather than updating the shadow storage 111-1 immediately upon receiving a shadow update request from software, such that the configuration may be changed at the same time point as that of the DDI.

When a VRR for changing the frame rate according to the application is supported, the AP 100 may transmit metadata including frame rate change information to the DDI 200 as a synchronous command. The AP 100 may identify that transmission of the synchronous command is completed, a frame rate setting value of the AP 100 may be updated to the same value as that of the DDI 200. Accordingly, the AP 100 and the DDI 200 may change frame rates in the same frame.

The DDI may determine an operating method according to the frame rate through information provided through a synchronous command. When increasing the frame rate, image data transmitted from the AP may be output by the panel on-the-fly. When the frame rate is lowered, the DDI may drive logic in hold to maintain the image data currently being output. In the VRR, when AP and DDI are not synchronized with information about frame rates, the DDI may need to output an image on-the-fly. A collision may occur due to holding an image, or conversely, the holding logic may not operate when the image needs to be maintained.

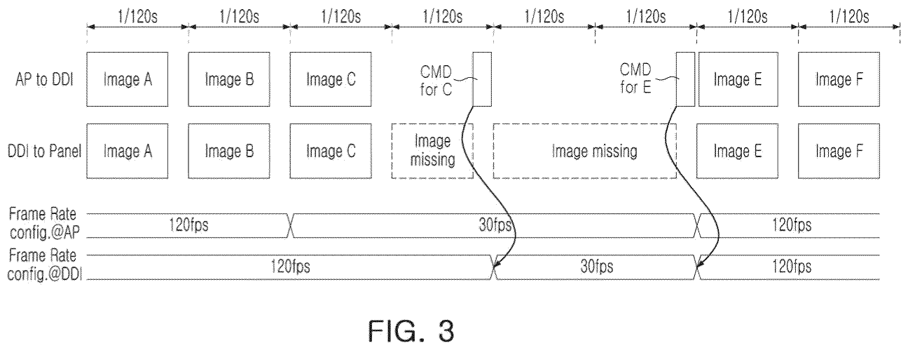

FIG. 3 is a diagram illustrating an example of image missing without a synchronous command. As illustrated in FIG. 3, a frame rate change command may be transmitted to the DDI late and the image to be maintained may not be maintained. After the AP changes the setting to 30 fps, the DDI may be set to 120 fps without receiving in advance information indicating that Image C may need to be held. Accordingly, the DDI may be in an image missing state in which the image which should be transmitted from the AP is not transmitted.

When the frame rate is lowered from 120 Hz to 30 Hz from the Image C, the command for changing the frame rate may be transmitted later than the Image C. The AP may not transmit image data after the Image C, but since the DDI receives information about the image hold time point late, the AP may be in a state in which there is no image data to be output to the panel after the Image C.

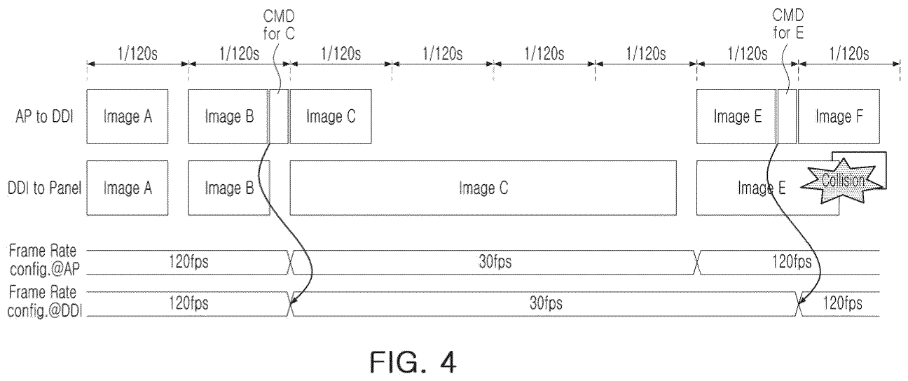

FIG. 4 is a diagram illustrating an example of image collision without a synchronous command. As illustrated in FIG. 4, a command to change from 30 fps to 120 fps may be transmitted late to the DDI, which may cause a collision by holding an image which should be transmitted on-the-fly. In this case, a jank phenomena in which frame fluctuations occurs or the frames pause may occur in view of a user.

When the frame rate increases from 30 Hz to 120 Hz from an Image E, the command for changing the frame rate may be transmitted later than the Image E. The AP may try to update a new Image F after the Image E, but the DDI may try to refresh the Image E, and thus the two images may collide and may be exposed to a frame-abnormality state.

In various example embodiments, such issues may be addressed such that operation of the VRR may be available, and accordingly, the system may have different frame rates according to an application, thereby enabling efficient power operation.

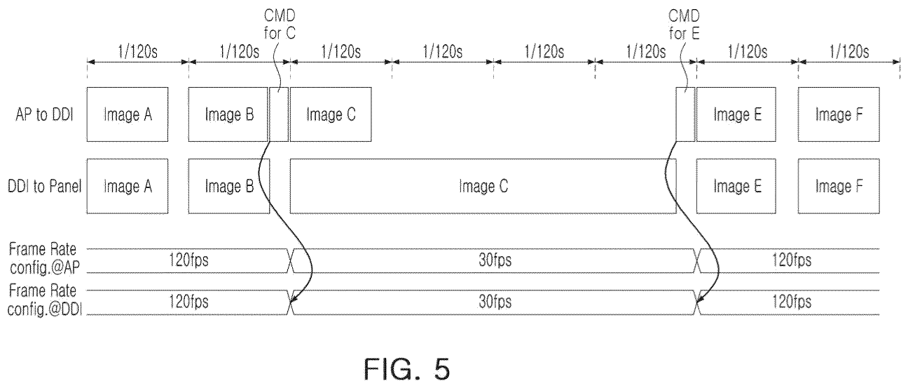

FIG. 5 is a timing diagram illustrating an operation of an AP 100 using a synchronous command according to an example embodiment. As illustrated in FIG. 5, when a synchronous command is included and the frame rate is lowered from 120 fps to 30 fps from the Image C, the AP 100 may transmit the frame rate change information to the DDI 200 as a synchronous command immediately before the Image C. The DDI 200 may receive the synchronous command, may change the frame rate to 30 fps, and may hold the Image C. The AP 100 may identify that the synchronous command transmission has been completed and may change the frame rate to 30 fps. Accordingly, the operation may be performed as intended by changing the frame rate in the same frame. Conversely, when increasing the frame rate from 30 fps to 120 fps, the frame rates of the AP 100 and the DDI 200 may be changed in the same frame through the synchronous command.

As illustrated in FIG. 5, by transmitting information about the frame rates changing prior to the Image C, where the frame rate is lowered from 120 Hz to 30 Hz, in the form of a synchronous command, to the DDI, an image may be held starting from the Image C. By transmitting information about the frame rates changing prior to the Image E, where the frame rate increases from 30 Hz to 120 Hz, in the form of a synchronous command, the DDI may output the Image E and the Image F immediately upon receiving the images from the AP.

In a related art AP, when the amount of commands piled up in storage is relatively large, it may take more than one frame for a newly written command to be transmitted, which may be more problematic when the frame rate is low as the transmission takes longer. By contrast, in an example embodiment, the AP 100 may transmit the synchronous command preferentially regardless of how many general commands are piled up.

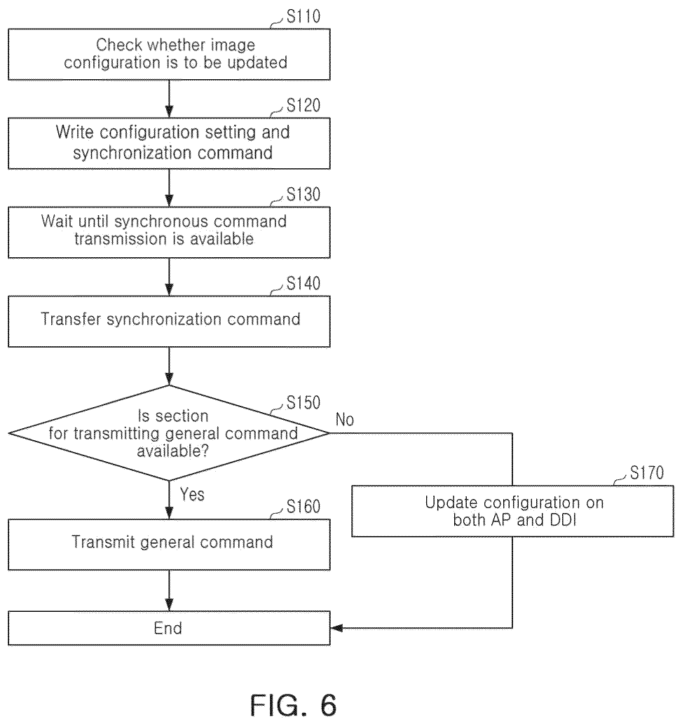

FIG. 6 is a flowchart illustrating an operation in which an AP 100 and a DDI 200 update configurations thereof in the same frame according to an example embodiment.

AP 100 may identify whether the image configuration is to be updated (S110). For example, the AP 100 may identify whether the image configuration needs to be updated according to an application. When the image configuration is to be updated, the configuration for a shadow storage among storages for settings within the AP may be input in advance. The AP 100 may write the configuration setting and the synchronization command (S120). For example, information for synchronous command storage may be input to the DDI in order to transmit information about the changed configuration in the form of a synchronous command. The AP 100 may wait until a synchronous command transmission is available (S130). For example, the AP 100 may wait until the frame partition logic 133 becomes an area in which synchronous command transmission is available. Generally, an area in which the synchronous command may be transmitted may be the vertical porch section of the frame immediately preceding the frame in which the configuration is updated.

The AP 100 may transfer the synchronization command (S140). For example, when transmission acknowledgment of the synchronous command is received, the AP may notify the DDI whether there is a transmission acknowledgment using an acknowledgment signal in the synchronous command control interface. The AP 100 may determine whether a section for transmitting a general command is available (S150). The AP may identify whether an allowable section for transmitting a general command remains even though the entirety of synchronous commands have been transmitted. When an allowable section remains (S150, Yes), the AP may transmit a general command. As for a general command, there may be no protocol for transmission acknowledgment. When the command transmission allowable section ends, transmission may also end (S160). When no allowable sections are left or when the entirety of general commands are transmitted (S150, No), the AP and the DDI may update the configuration (S170). For example, the AP and DDI may update the configuration according to the frame start time point (S170).

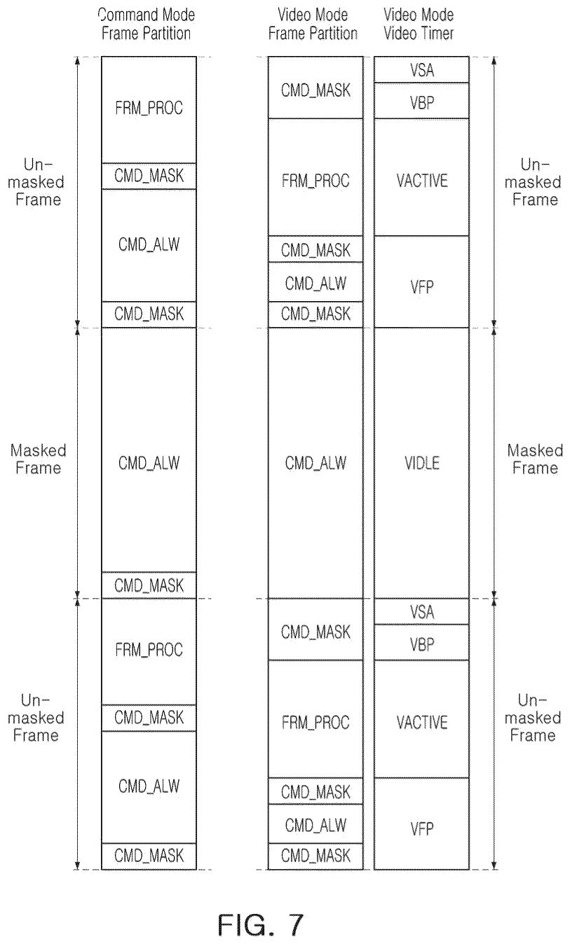

FIG. 7 is a diagram illustrating a related art AP data arbitration operation. FIG. 7 illustrates frame partitions corresponding to each of video mode and command mode in the related art. A frame (hereinafter, an un-masked frame) configured to transmit an image in the prior art may include frame processing section (FRM_PROC)/command allowable section (CMD_ALW)/command mask section (CMD_MASK) section. A frame (a masked frame) in which an image is not transmitted may be classified as a CMD_ALW section. Image data may be transmitted in the FMR_PROC section of the un-masked frame, and command transmission may be allowed in the CMD_ALW. The CMD_MASK may be a section in which a command is not able to be transmitted, and may be configured to prevent image transmission in FRM_PROC from being delayed due to the command transmission which starts in the CMD_ALW but does not end, and to prevent collision in data processing. In a masked frame, the entire section may correspond to the CMD_ALW section, such that command transmission may be allowed.

When commands stored in storage are present in a section in which command transmission is allowed, the commands may be transmitted in sequence. In command mode, similarly, the unmasked frame may include FRM_PROC/CMD_ALW/CMD_MASK sections. The masked frame may include CMD_ALW/CMD_MASK sections. Image data may be transmitted in the FRM_PROC state of the un-masked frame, and command transmission may be allowed in the CMD_ALW state.

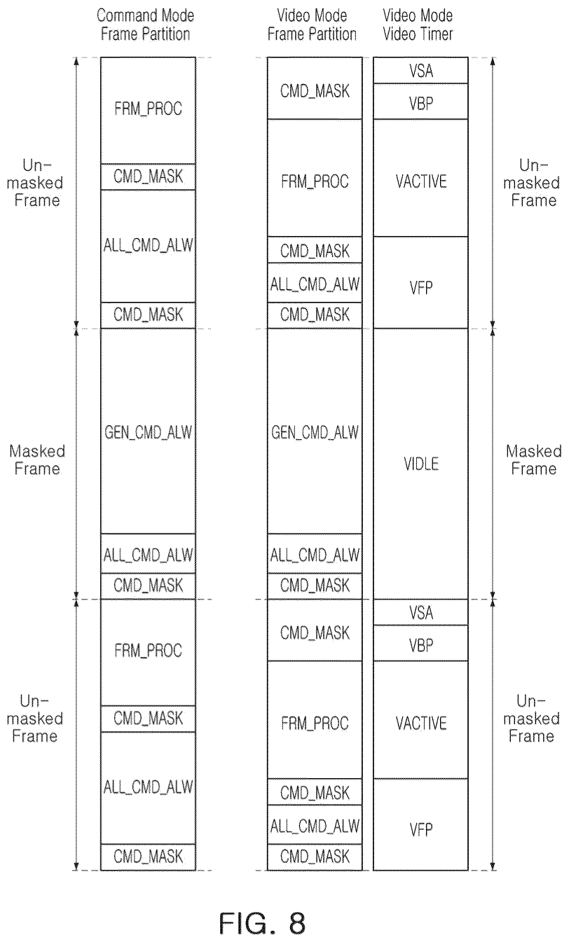

FIG. 8 is a diagram illustrating a data arbitration operation according to an example embodiment. Referring to FIG. 8, a frame partition may be different from the example in FIG. 7. In video mode, a synchronous command may be transmitted preferentially in response to a synchronous command transmission request in the ALL_CMD_ALW section of the un-masked frame, and when there is still time for command transmission, general command transmission may be allowed. In the masked frame, the CMD_ALW section may have three states as below: GEN_CMD_ALW/ALL_CMD_ALW/CMD_MASK.

In the GEN_CMD_ALW state, transmission of only a general command may be available. The reason for not allowing synchronous command transmission in this state may be to simplify DDI operation by ensuring the interval between the synchronous command and image data synchronized with the synchronous command are similar regardless of the un- masked frame or the masked frame.

The ALL_CMD_ALW state may transmit a synchronous command when there is a synchronous command transmission request, and may transmit a general command when there is no synchronous command transmission request. Similarly to the ALL_CMD_ALW section in the vertical frame porch (VFP) of the un-masked frame, synchronous command transmission has been completed, and general command transmission may be allowed when the time to allow command transmission remains. The command mode may operate in the same manner as video mode.

In video mode, a frame start may be performed in a light emission cycle unit such as ½ or ¼ points of the masked frame using a light emission synchronization signal.

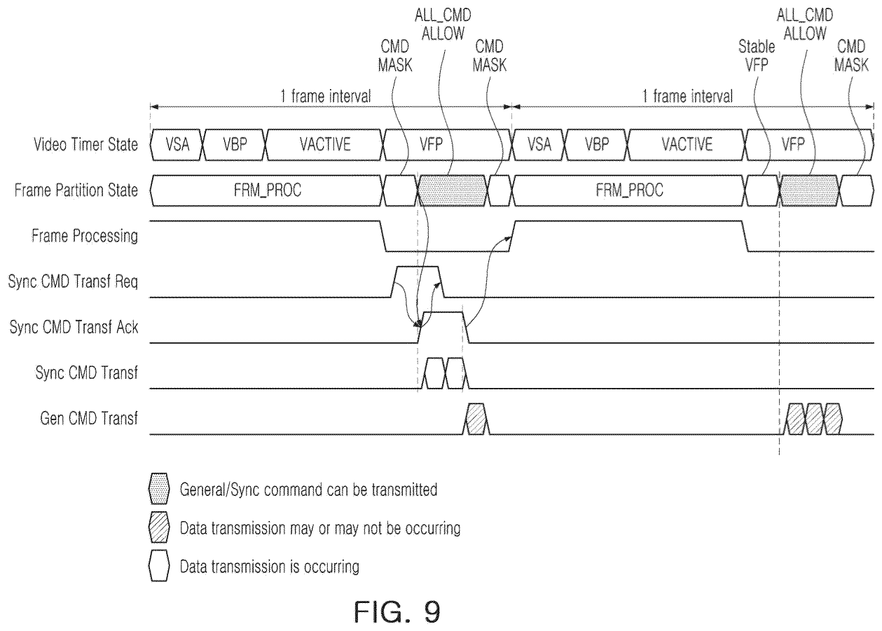

FIG. 9 is a diagram illustrating timing of a protocol of a synchronous command transmission interface in an AP according to an example embodiment. When a synchronous command is to be transmitted, a display control logic 110 may transmit a synchronous command transmission request signal (Sync CMD Transf Req) to a DDI. Thereafter, when the frame partition state is ALL_CMD_ALW, an AP may assert a synchronous command transmission acknowledgment signal (Sync CMD Trnasf Ack) for synchronous command transmission, may read synchronous command data from a storage, may package the data, and may transmit the data (Sync CMD Transf) to the DDI. As illustrated in FIG. 9, since the synchronous command transmission request signal is handshaked with an acknowledgment signal, the synchronous command transmission request signal may be de-asserted.

When the entirety of synchronous command data is transmitted and the storage becomes empty, the AP may de-assert the acknowledgment signal. The display control logic 110 may operate to request a shadow update of configuration and to start a frame only after the acknowledgment signal reaches the row level state (frame processing), thereby ensuring that the entirety of synchronous commands have been transmitted before the frame update.

As illustrated in FIG. 9, a command transmission allowable section may remain after synchronous command transmission is completed, and a general command may be transmitted in the remaining section. Since the synchronous command transmission request signal is not asserted (i.e., de-asserted) in the ALL_CMD_ALW section, only the general command may be transmitted.

The example embodiments may also be used when switching between video mode and command mode. When changing the operation mode from video mode to command mode, an image of a last frame operating in video mode may be transmitted, information about the operation mode change may be transmitted as a synchronous command and the mode may be switched to command mode. In an example embodiment, the same method may be used when switching from command mode to video mode.

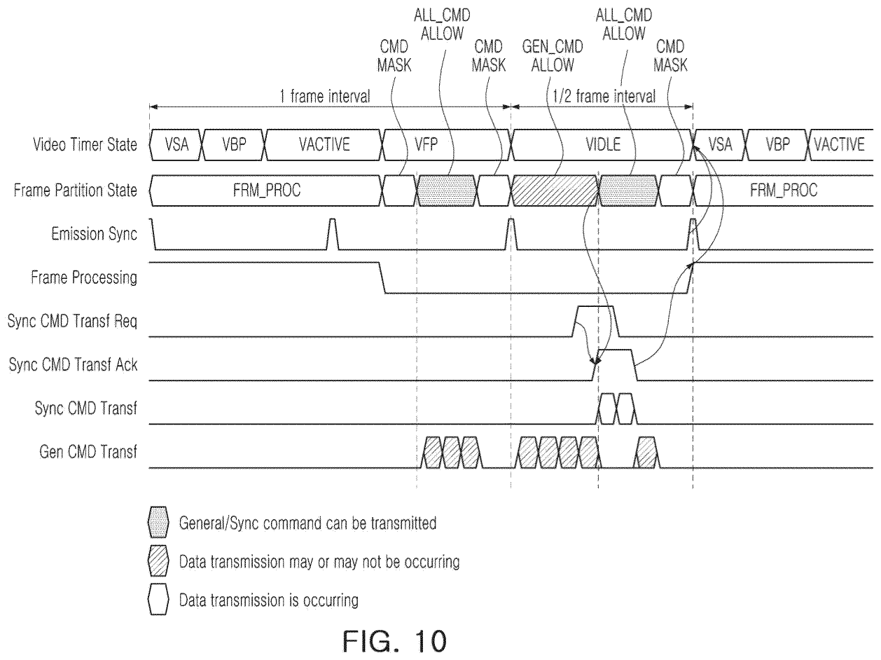

FIG. 10 is a timing diagram illustrating an example of when emission synchronization is used in an AP 100 according to an example embodiment. Basically, a frame update may start at 1 frame interval, that is, corresponding to a vertical synchronous signal, but when a light emission synchronization function is used, a frame start may also be available at a ½ frame, or a ¼ frame or a ¾ frame, based on an emission synchronization (Emission Sync) signal. When the synchronous command and the emission synchronization in example embodiments are combined, frame partitioning may be performed in accordance with the emission synchronization interval in a vertical frame idle (VIDLE) section, such that, in the case in which transmission of the synchronous command is able to be completed, a new frame may start according to emission synchronization without waiting for 1 frame interval.

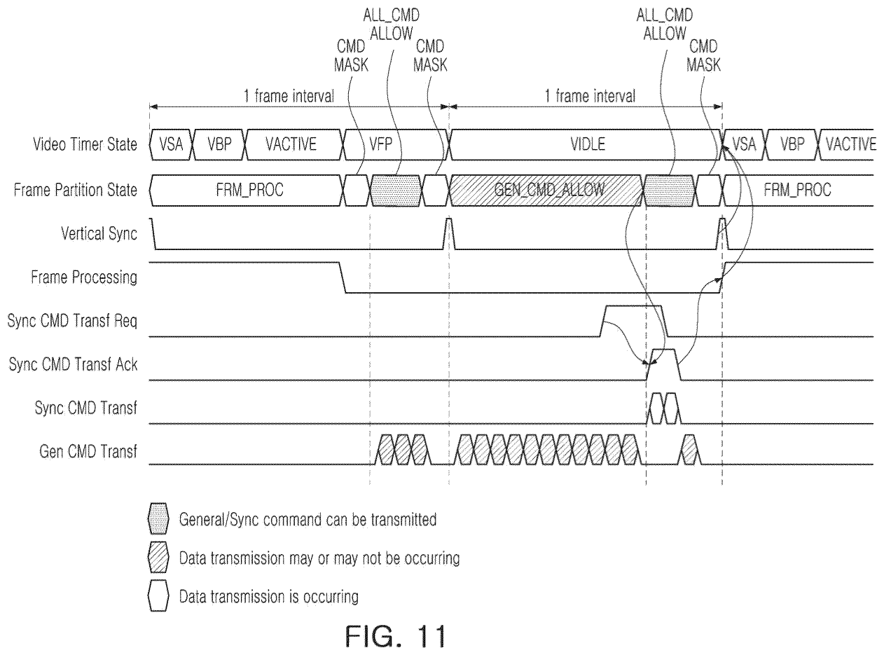

FIG. 11 is a diagram illustrating timing when an AP 100 does not use a light emission synchronization signal when transmitting a synchronous command according to an example embodiment. In this case, in a vertical frame idle section (VIDLE), the frame partition be classified as 1 frame interval, and even when a frame update is requested in the middle of the frame, transmission of a new frame may start immediately in accordance with the vertical synchronization signal after waiting for 1 frame interval. The command transmission operation in FIG. 10 may have a faster response speed as compared to the example in FIG. 11.

In FIGS. 10 and 11, it may be assumed that a frame update is requested immediately after a 1st frame. In the example in FIG. 10 in which emission synchronization is used, a frame start may begin after a ½ frame interval. In the example in FIG. 11 in which emission synchronization is not used, a frame start may begin after 1 frame interval. Even when a new frame in which the frame configuration changes is updated, the Vertical Sync command may be combined with the emission synchronization and may support configuration synchronization of the AP and the DDI, and may also maintain the effect of increasing a frame update response speed.

During a partial display update in which updating is performed by transmitting only a portion of information of a frame, synchronous command transmission in an example embodiment may be used.

Even when only a portion in a display changes on a frame for a user, an image for the entire frame may need to be transmitted. However, in a partial display, only the image of a partially changed section of the frame may be transmitted. To this end, the image corresponding to the entire frame may first be transmitted and the entire image data may be held in the DDI. Thereafter, by transmitting only partial image data, only the image data of the corresponding area may be updated from the existing image data and may be output to a panel. By using the synchronous command of an example embodiment in the partial display, the AP may transmit a command to hold along with the image data held by the DDI as a synchronous command. The AP may transmit the metadata of the updated partial image data by transmitting the synchronous command along with the partial image data to the DDI.

The AP and the synchronous command transmission method thereof according to an example embodiment may be applied to the entirety of functions that are updated by a frame unit, such as changing a resolution and activating an image post-processing logic such as image up-scaling. Through a protocol analyzer, transmission of data of a specific pattern may be able to be identified whenever the fps changes.

The example embodiments may operate in conjunction with a tearing effect (TE) signal. In the mobile industry processor interface display serial interface (MIPI DSI) standard, a TE signal may be used to transmit display timing information to a host processor. The TE signal may be related to the frame update of a display and may be used mainly in the graphic rendering and display update process. The TE signal may be used to synchronize with a refresh cycle of a display device. A display may have a frame update cycle used to refresh an image at a constant rate, and may update a frame within the cycle. The TE signal may inform the host processor of the display update cycle, such that the host may transmit data at an appropriate time or may wait for the display to be updated. TE signals may be generated at a DSI protocol layer and may be transmitted through a PHY layer of a display device. The TE signal may be used to control efficient data communication and display update between the display and the host, and may be used in smoothly processing a video output of a display.

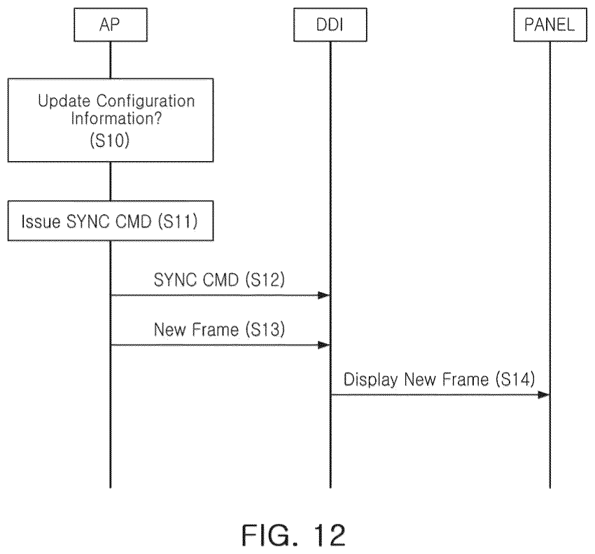

FIG. 12 is a ladder diagram illustrating an operation of a display system according to an example embodiment. The AP may determine whether to update configuration information (S10). For example, the AP may determine whether to update the configuration information according to an application in video mode (S10). The AP may issue a synchronous command (SYCN CMD) (S11). For example, the AP may issue the synchronous command (SYCN CMD) when configuration information is to be updated. The AP may transmit the synchronous command to a DDI (S12). The DDI may receive the synchronous command, may respond to the synchronous command and may perform synchronization for frame reception in a newly configured manner. Thereafter, the AP may transmit a new frame to the DDI (S13). The DDI may transmit a new frame to be output on a panel (S14).

In an example embodiment, the synchronous command may be stored in dedicated synchronous command storage that is different from a storage configured to store a general command. In an example embodiment, the AP may determine whether to update configuration information using a synchronous command transmission request signal and may issue a synchronous command to update the configuration information. In an example embodiment, the AP may determine whether general command transmission other than the synchronous command is available, and when general command transmission is available, the AP may transmit the general command to the DDI. In an example embodiment, the synchronous command may be transmitted in a command allowable section of a vertical frame porch (VFP) section. In an example embodiment, the general command may be transmitted in the vertical frame porch (VFP) section. In an example embodiment, the synchronous command may be transmitted between neighboring emission synchronization signals. In an example embodiment, a vertical synchronization activation (VSA) section may start in response to a synchronous command transmission acknowledgment signal indicating transmission acknowledgment of the synchronous command. In an example embodiment, the synchronous command may be transmitted between neighboring vertical synchronization signals. In an example embodiment, the synchronous command transmission request signal may be received using a tearing effect (TE) signal.

FIG. 12 may illustrate synchronous commands issued in video mode. However, example embodiments are not limited thereto. The synchronous command in an example embodiment may also be issued in command mode. That is, the synchronous command in an example embodiment may be issued in both video mode and command mode.

The example embodiments may be applicable to a mobile device.

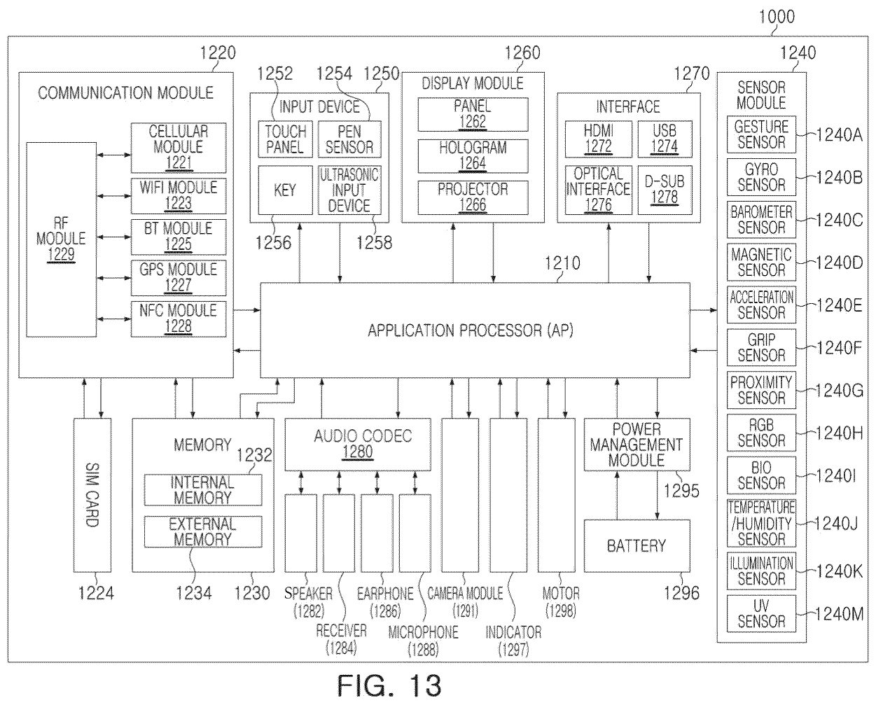

FIG. 13 is a diagram illustrating a mobile device according to an example embodiment. Referring to FIG. 13, the mobile device 1000 may include at least one application processor (AP) 1210, a subscriber identification module (SIM) card 1224, a memory 1230, a communication module 1220, a sensor module 1240, a input device 1250, a display module 1260, an interface 1270, an audio codec 1280, a camera module 1291, a power management module 1295, a battery 1296, an indicator 1297 and a motor 1298.

The application processor (AP) 1210 may include one or more application processors (APs). In some embodiments, the mobile device 1000 may include at least one communication processor (CP) in additional to the one or more application processors (APs). In some embodiments, the AP 1210 and the CP may be AP 1210 included in a processor, but the AP 1210 and the CP may be included in different IC packages. In an example embodiment, the AP 12101210 and the CP may be included within an IC package.

The AP 1210 may drive an operating system or an application program and may control multiple hardware or software components connected to the AP 1210, and may perform various data processing and computation, including multimedia data. The AP 1210 may be implemented, for example, as a system on chip (SoC). In an example embodiment, the AP 1210 may further include a graphics processing unit. In an example embodiment, the AP 1210 may be implemented to transmit a synchronous command at a specific image transmission time point as described in FIGS. 1 to 12.

The CP may perform a function of managing data links and converting communication protocols in communication between electronic devices, including the mobile device 1000, and other electronic devices connected to a network. The CP may be implemented, for example, as a SoC. In an example embodiment, the CP may perform at least a portion of a multimedia control function. The CP may, for example, use a user identification module (e.g., SIM card 1224) to identify and authenticate a terminal within a communication network. The CP may provide a user with services such as voice calls, video calls, text messages, or packet data. The CP may control data transmission and reception of the communication module 1220. In FIG. 13, components such as the power management module 1295 or the memory 1230 are illustrated as separate components from the AP 1210, but in an example embodiment, the AP 1210 may include at least a portion of the aforementioned components.

In an example embodiment, the AP 1210 or the CP may process a command or data received from at least one of a non-volatile memory or other components connected to the AP 1210 or the CP by loading the command or the data into a volatile memory. The AP 1210 or the CP may store data received from at least one of the other components or generated by at least one of the other components in a non-volatile memory.

The SIM card 1224 may be a card implementing a user identification module, and may be inserted into a slot formed at a designated position of an electronic device or embedded in a device in the form of a chip, or SIM information may be stored in the device without a physical form (e.g., an electronic SIM, a virtual SIM, or a soft SIM). The SIM card 1224 may include unique identification information (e.g., an integrated circuit card identifier (ICCID)) or user information (e.g., an international mobile subscriber identity (IMSI)). The SIM card 1224 may operate in relation to the communication module 1220.

The memory 1230 may include an internal memory 1232 or an external memory 1234. The internal memory 1232 may include, for example, a volatile memory (e.g., DRAM (dynamic RAM), static RAM (SRAM), synchronous dynamic RAM (SDRAM), or the like) or a non-volatile memory (e.g., one time programmable ROM (OTPROM), programmable ROM (PROM), erasable and programmable ROM (EPROM), electrically erasable and programmable ROM (EEPROM), mask ROM, flash ROM, NAND flash memory, NOR flash memory, or the like).

The external memory 1234 may include a flash drive, for example, compact flash (CF), secure digital (SD), micro secure digital (Micro-SD), mini secure digital (Mini-SD), extreme digital (xD) or memory stick.

The communication module 1220 may include a wireless communication module or an RF module 1229. The wireless communication module may include, for example, a cellular module 1221, a Wi-Fi module 1223, a Bluetooth (BT) module 1225, a GPS module 1227, and/or a near field communication (NFC) module 1228. For example, the wireless communication module may provide a wireless communication function using wireless frequency. The wireless communication module may include a network interface (e.g., LAN card) or modem to connect the mobile device 1000 to a network (e.g., Internet, LAN, WAN, telecommunication network, cellular network, satellite network, or POTS, or the like).

The RF module 1229 may be responsible for transmitting and receiving data, for example, transmitting and receiving an RF signal or a called electronic signal. Although not illustrated, the RF module 1229 may include, for example, a transceiver, a power amp module (PAM), a frequency filter, or a low noise amplifier (LNA). The RF module 1229 may further include components for transmitting and receiving electromagnetic waves in free space in wireless communication, for example, conductors or wires.

The sensor module 1240 may include, for example, at least one of a gesture sensor 1240A, a gyro sensor 1240B, a barometer sensor 1240C, a magnetic sensor 1240D, an acceleration sensor 1240E, a grip sensor 1240F, a proximity sensor 1240G, an RGB (red, green, blue) sensor 1240H, a biometric (BIO) sensor 1240I, a temperature/humidity sensor 1240J, an illuminance sensor 1240K, and/or a ultraviolet (UV) sensor 1240M. The sensor module 1240 may measure physical quantities or may sense an operating state of an electronic device and may convert the measured or sensed information into an electrical signal. The sensor module 1240 may include, for example, an olfactory sensor (E-nose sensor), an electromyography sensor (EMG sensor), an electroencephalogram sensor (EEG sensor), an electrocardiogram sensor (ECG sensor), a photoplethysmography sensor (PPG sensor), a heart rate monitor (HRM) sensor, a perspiration sensor, or a fingerprint sensor. The sensor module 1240 may further include a control circuit for controlling at least one sensor included therein.

The input device 1250 may include a touch panel 1252, a pen sensor 1254, a key 1256, and/or an ultrasonic input device 258. For example, the touch panel 1252 may recognize a touch input using at least one of capacitive, pressure-sensitive, infrared, or ultrasonic methods. The touch panel 1252 may further include a controller. In the case of a capacitive type method, direct touch and also proximity recognition may be performed. The touch panel 1252 may further include a tactile layer. In this case, touch panel 1252 may provide a tactile response to a user.

For example, the pen sensor 1254 may be implemented using a method the same as or similar to the method of receiving a touch input of a user or using a separate recognition sheet. As the key 1256, for example, a keypad or a touch key may be used. The ultrasonic input device 1258 may identify data by sensing sound waves from a terminal to a microphone (e.g., microphone 1288) through a pen generating an ultrasonic signal, and may enable wireless recognition. In an example embodiment, the mobile device 1000 may receive a user input from an external device (e.g., a network, computer, or server) connected thereto using the communication module 1220.

The display module 1260 may include a panel 1262, a hologram 1264, and/or a projector 1266. The panel 1262 may be implemented as, for example, a liquid-crystal display (LCD) or an active-matrix organic light-emitting diode (AM-OLED). The panel 1262 may be implemented to be, for example, as flexible, transparent or wearable. The panel 1262 may be configured as a module with the touch panel 1252. The hologram 1264 may display a three- dimensional image in the air using light interference. In an example embodiment, the display module 1260 may further include a control circuit for controlling the panel 1262, the hologram 1264, and/or the projector 1266.

The interface 1270 may include, for example, a HDMI 1272, a USB 1274, an optical interface 1276, and/or a D-subminiature (D-sub) 1278. The interface 1210 may include, for example, a multi-media card (SD/MMC) or infra-red data association (IrDA).

The audio codec 1280 may convert voice and electrical signals bidirectionally. The audio codec 1280 may convert a voice information input or output through, for example, a speaker 1282, a receiver 1284, an earphone 1286, and/or a microphone 1288. The camera module 1291 may capture images and videos, and may include at least one image sensor (e.g., a front lens or a rear lens), an image signal processor (ISP), or a flash LED in an example embodiment.

The power management module 1295 may manage power of the mobile device 1000. Although not illustrated, the power management module 1295 may include, for example, a power management integrated circuit (PMIC), a charger integrated circuit (IC), or a battery fuel gauge. The PMIC may be mounted, for example, in an integrated circuit or a SoC semiconductor. Charging methods may include wired and wireless methods. The charging IC may charge a battery and may prevent overvoltage or overcurrent from flowing in from a charger. In an example embodiment, the charging IC may include a charging IC for at least one of a wired charging method or a wireless charging method. The wireless charging method may include, for example, a magnetic resonance method, magnetic induction method, or an electromagnetic wave method, and additional circuits for wireless charging, such as a coil loop, a resonance circuit, and a rectifier, may be added. The battery gauge may, for example, measure remaining power, voltage, current or temperature during charging of the battery 1296. The battery 1296 may generate electricity and supply power, and may be implemented as, for example, a rechargeable battery. The indicator 1297 may display a designated state of the mobile device 1000 or a portion thereof (e.g., AP 1210), for example, a booting state, message state, or charging state. For example, the booting state, message state, or charging state may be displayed. The motor 1298 may convert an electrical signal into mechanical vibrations. Although not illustrated, the mobile device 1000 may include a processing device (e.g., GPU) for mobile TV support. The processing devices for mobile TV support may, for example, process media data according to standards such as digital multimedia broadcasting (DMB), digital video broadcasting (DVB) or media flow.

Each of the above-described components of hardware according to various example embodiments may be configured as one or more components, and the names of the corresponding configuration elements may vary according to the type of electronic device. Hardware according to various example embodiments may be configured to include at least one of the aforementioned components, and some components may be omitted or other additional components may be further included. Also, a portion of the hardware configuration elements according to various example embodiments are combined and configured into a single entity, such that the functions of the corresponding configuration elements before being combined may be performed in the same manner.

The example embodiments may be applicable to an electronic device having a display system.

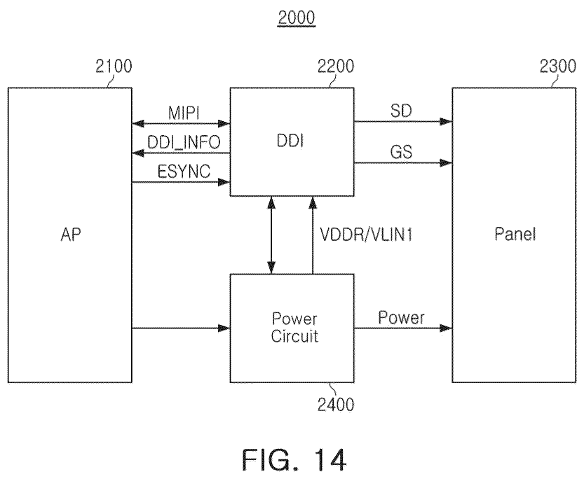

FIG. 14 is a diagram illustrating an electronic device 2000 according to an example embodiment. Referring to FIG. 14, the electronic device 2000 may include a processor (AP) 2100, a display driver interface circuit (DDI) 2200, a panel 2300, and a power circuit 2400.

The processor (AP) 2100 may be implemented to control overall operation of a display device. In an example embodiment, the processor 2100 may be implemented as an integrated circuit, system-on-chip, or mobile application processor (AP). The processor (AP) 2100 may transmit data to be displayed (e.g., image data, video data, or still image data) to the display driver integrated circuit (DDI) 2200. In an example embodiment, data may be classified in source data (SD) unit corresponding to a horizontal line (or vertical line) of the panel 2300. The processor (AP) 2100 may be implemented to issue a synchronous command in response to a synchronous command transmission request of the DDI, as described in FIGS. 1 to 12.

The display driver interface (DDI) 2200 may change data transmitted from the processor (AP) 2100 into a form which may be transmitted to the panel 2300 and may transmit the changed data to the panel 2300. The source data (SD) may be supplied in pixel units. The first side channel signal (DDI_INFO) may be transmitted to the connected processor (AP) 2100 according to determination of the display driver interface (DDI) 2200. The first side channel signal (DDI_INFO) may be output to the processor (AP) 2100 using the tearing effect (TE) pin. The second side channel signal (ESYNC) may be a video timing of the display driver interface (DDI) 2200. The second side channel signal (ESYNC) may be transmitted periodically through the display driver interface (DDI) 2200. A modulation function may be applied to the second side channel signal (ESYNC) for failsafe. In an example embodiment, the second side channel signal (ESYNC) may be output by the processor (AP) 2100 using an error detection flag pin.

The display driver integrated circuit (DDI) 2200 may control a level of a logic voltage (VDDR)/analog voltage (VLIN1) by communicating with the power circuit (PMIC) 2400. The processor interface may interface signals or data exchanged between the processor (AP) 2100 and the display driver integrated circuit (DDI) 2200. The processor interface may be transmitted to the display driver integrated circuit (DDI) 2200 by interfacing source data (SD, line data) transmitted from the processor (AP) 2100. In an example embodiment, the processor interface may be configured as an interface related to a serial interface such as mobile industry processor interface (MIPI), mobile display digital interface (MDDI), display port, or embedded display port (eDP). The panel 2300 may include a gating signal (GS) may be implemented to display source data (SD) by the display driver integrated circuit (DDI) 2200. In an example embodiment, the panel 2300 may be a display panel configured as a low temperature poly crystalline oxide (LTPO) panel.

A power circuit 2400 may be implemented to manage power of a display device. In an example embodiment, the power circuit 2400 may include a power management integrated circuit (PMIC), a charger integrated circuit (IC), and/or a battery or fuel gauge. The power circuit 2400 may have a wired and/or wireless charging method. The wireless charging method may include, for example, a magnetic resonance method, a magnetic induction method or an electromagnetic wave method, and may further include an additional circuit for wireless charging, for example, a coil loop, a resonance circuit, or a rectifier.

The power circuit 2400 may receive a command from the processor (AP) 2100 and may supply power to each portion of the electronic device 2000. The power circuit 2400 may supply power to the display driver integrated circuit (DDI) 2200 and the panel 2300. For example, the power circuit 2400 may provide an external voltage to the display driver integrated circuit (DDI) 2200. The external voltage may be processed and used in the display driver integrated circuit (DDI) 2200. The power interface may interface between the power circuit 2400 and the display driver integrated circuit (DDI) 2200. For example, the power interface may transmit commands from the display driver integrated circuit (DDI) 2200 to the power circuit 2400. The power interface may be provided separately from the processor interface. The display driver integrated circuit (DDI) 2200 may be connected directly to the power circuit 2400 without going through the processor (AP) 2100.

The power circuit 2400 may receive a power setting command from the display driver integrated circuit (DDI) 2200 and may control a level of power (VDDR/VLIN1) in each portion of the display device.

The device described above may be implemented with hardware components, software components, and/or a combination of hardware components and software components. For example, the device and components described in an example embodiment may be implemented using one or more general-purpose or special-purpose computers such as a processor, a controller, an arithmetic logic unit (ALU), a digital signal processor, a microcomputer, a field programmable gate array (FPGA), and a programmable logic unit (PLU), a microprocessor, or any other device which may execute instructions and respond. A processing device may execute an operating system (OS) and one or more software applications performed on an operating system. A processing device may access, store, manipulate, process and generate data in response to the execution of software. For ease of description, a single processing device may be used, but the processing device may include a plurality of processing elements or a plurality of types of processing elements. For example, a processing device may include a plurality of processors or a processor and a controller. Other processing configurations, such as parallel processors, may be available.

Software may include a computer program, codes, instructions, or a combination of one or more thereof, and may configure the processing device to operate as desired or to instruct the processing device independently or collectively. Software and/or data may be embodied in any type of machine, component, physical device, virtual equipment, computer storage medium or device to be interpreted by or to provide instructions or data to a processing device. Software may be distributed over networked computer systems and may be stored or executed in a distributed manner. Software and data may be stored on one or more computer-readable recording media.

According to the application, the demand for dynamic VRR, which is a function of changing configurations such as frame rates and resolution in frame unit, may increase. To prevent frame abnormality, it may be advantageous for the AP and the DDI to change configurations thereof in the same frame. Synchronization of the time point for transmitting configuration information to the DDI with the time point for updating the configuration may be advantageous. A related art AP may have no dependency between command data and image data, such that commands may be transmitted in the order of being stored in a transmittable section within a frame. When metadata of a specific image is transmitted as a command, the command may be transmitted later than an image or may be transmitted more than 1 frame earlier, such that it may be difficult to match the metadata with the image in the DDI. Since it is difficult to identify whether a specific command has completed transmission through the DDI, it may also be difficult for the AP to perform synchronization of the time point for updating the configuration.

Generally, in command mode, the frame update cycle may be determined by receiving a TE from the DDI, but in video mode, the cycle may be determined by the AP. Software of the AP according to an example embodiment may recognize that the frame rate may need to be changed according to an application and may request synchronous command transmission.

According to an example embodiment, the AP may provide priority to command transmission of a command (e.g., a synchronous command) for which a time of transmission is important by storing the command (e.g., the synchronous command) for which the time of transmission is important separately from an existing general command (e.g., general command). The AP in an example embodiment may control the time of transmission of the synchronous command through a request signal and may identify whether transmission is completed using an acknowledgement signal. By synchronizing the time of transmission of image data with the synchronous commands, the AP and the DDI may share the configuration in the same frame. The image jank phenomenon which may occur when implementing a dynamic VRR may be addressed. Synchronization of configurations of the AP and the DDI through the synchronous command may be performed. The AP of an example embodiment may be implemented as a device which may assign priority to the synchronous command by distinguishing properties of command data. The AP in an example embodiment may be implemented as a device which may change configuration in frame unit through shadow update. The AP in an example embodiment may be implemented as a device which may ensure data transmission by inducing transmission of the synchronous command and notifying transmission acknowledgment.

According to the aforementioned example embodiments, in the example embodiments, the synchronous command may be transmitted at a specific image transmission time point. In the example embodiments, the time of transmission of a synchronous command may be specified by storing the synchronous command in a separate storage. In the example embodiments, transmission of the synchronous command may be ensured prior to specific image transmission by identifying command transmission acknowledgment. In the example embodiments, the frame rate may be changed at a desired time point during operation using a synchronous command. In the example embodiments, the frame rate may be changed at the same time point in the application processor and the display driving chip. In the example embodiments, variable refresh rate mode may be dynamically supported.

The AP according to an example embodiment may be implemented by a configuration synchronization between the AP and the DDI through a synchronous command. The AP of an example embodiment may include a device assigning priority to the synchronous command by distinguishing properties of command data. The AP in an example embodiment may include a device for changing configuration in frame unit through shadow update. The AP according to an example embodiment may include a device which may ensure data transmission by inducing transmission of the synchronous command and notifying transmission acknowledgment.

While various example embodiments have been illustrated and described above with respect to the drawings, it will be apparent to those skilled in the art that modifications and variations could be made without departing from the scope of the present disclosure as defined by the appended claims.

1. A method of operating an application processor, the method comprising:
determining whether to update configuration information according to an application;
issuing a synchronous command when the configuration information is to be updated;
transmitting the synchronous command to a display driver integrated circuit; and
after receiving a transmission acknowledgment of the synchronous command from the display driver integrated circuit, transmitting frame data according to a frame rate corresponding to the synchronous command to the display driver integrated circuit.

2. The method of claim 1, further comprising:
storing the synchronous command in a synchronous command storage.

3. The method of claim 1, wherein the synchronous command is issued in at least one of video mode or command mode.

4. The method of claim 3, further comprising:
determining whether transmitting a general command to the display driver integrated circuit is allowed; and
transmitting the general command to the display driver integrated circuit when transmitting the general command is allowed.

5. The method of claim 4, wherein the synchronous command is transmitted in a command allowable section of a vertical frame porch section.

6. The method of claim 4, wherein the general command is transmitted in a vertical frame porch (VFP) section.

7. The method of claim 1, wherein the synchronous command is transmitted between neighboring emission synchronization signals.

8. The method of claim 1, wherein a vertical synchronization activation (VSA) section starts in response to a synchronous command transmission acknowledgment signal instructing the transmission acknowledgment of the synchronous command.

9. The method of claim 1, wherein the synchronous command is transmitted between neighboring vertical synchronization signals.

10. The method of claim 1, wherein, after the transmission acknowledgment of the synchronous command is received from the display driver integrated circuit, the application processor and the display driver integrated circuit change the configuration information when a frame starts.

11. An application processor comprising:
a synchronous command storage configured to store a synchronous command;
a general command storage configured to store a general command;
a display control logic configured to determine whether configuration information is to be changed according to an application and to generate the synchronous command when the configuration information is to be changed;
an arbitration logic configured to arbitrate transmission of the synchronous command, the general command, and frame data;
a frame section setter configured to set frame sections for each of a video mode and a command mode;
a packaging logic configured to convert data output by the arbitration logic into a packet; and
a physical layer circuit configured to transmit the packet to a display driver integrated circuit.

12. The application processor of claim 11, wherein a synchronous command transmission acknowledgment signal corresponding to the synchronous command is received from the display driver integrated circuit.

13. The application processor of claim 12, wherein the frame data is transmitted to the display driver integrated circuit in response to the synchronous command transmission acknowledgment signal.

14. The application processor of claim 11, wherein the display control logic includes a configuration storage configured to store configuration information related to frame transmission.

15. The application processor of claim 14, wherein the configuration storage includes:
a shadow storage configured to store configuration information related to transmission of subsequent frame data; and
an active storage configured to read the configuration information stored in the shadow storage in response to a shadow update request and to output the configuration information to the arbitration logic and the frame section setter after a transmission acknowledgment of the synchronous command.

16. A method of operating an application processor, the method comprising:
transmitting a synchronous command to a display driver integrated circuit in a command transmission allowable section in video mode; and
transmitting a general command to the display driver integrated circuit after a transmission acknowledgment of the synchronous command is received.

17. The method of claim 16, further comprising:
determining whether configuration information is to be updated according to an application.

18. The method of claim 16, further comprising notifying the display driver integrated circuit of an initiation of a transmission of the synchronous command and the transmission acknowledgment of the synchronous command.

19. The method of claim 16, further comprising:
transmitting frame data to the display driver integrated circuit after the transmission acknowledgment of the synchronous command is received.

20. The method of claim 16, wherein priority is given to the synchronous command by distinguishing properties of the synchronous command and properties of the general command.

21-25. (canceled)
